(19) United States
(12) Patent Application Publication
(10) Pub. No.: US 2014/0134421 A1
(43) Pub. Date: May 15, 2014

(54) CONDUCTIVE INK COMPOSITION AND TRANSPARENT CONDUCTIVE FILM

(71) Applicants: Jtouch Corporation, Taoyuan Hsien (TW); Industrial Technology Research Institute, Hsinchu (TW)

(72) Inventors: Chih-Ming HU, Hsinchu City (TW); Meng-Jung LI, Hsinchu City (TW); Yu-Chou YEH, Taipei City (TW)

(73) Assignees: Jtouch Corporation, Taoyuan Hsien (TW); Industrial Technology Research Institute, Hsinchu (TW)

(21) Appl. No.: 14/045,167

(22) Filed: Oct. 3, 2013

(30) Foreign Application Priority Data
Nov. 9, 2012 (TW) 101141731

(51) Int. Cl. C09D 11/00; H01B 1/22

(52) U.S. Cl. CPC C09D 11/52; H01B 1/22
USPC 428/292.1; 252/512; 252/514; 252/513; 428/457; 428/448; 428/469; 428/472; 428/471; 428/324

(57) ABSTRACT

The present disclosure provides a conductive ink composition, including: 100-70 parts by weight of solvent; 0.05-10 parts by weight of nano-metal wires; and 0.01-20 parts by weight of dispersant, wherein the dispersant includes alkyl benzene sulfonate, alkylphenyl sulfonate, alkyl naphthalene sulfonate, sulfate of higher fatty acid ester, sulfonate of higher fatty acid ester, sulfate of higher alcohol ester, sulfonate of higher alcohol ester, or a combination thereof. The present disclosure also provides a transparent conductive film made by the conductive ink composition

### CROSS REFERENCE TO RELATED APPLICATIONS

This application claims priority of Taiwan Patent Application No. 10114173, filed on 9 Nov., 2012, the entirety of which is incorporated by reference herein.

### TECHNICAL FIELD

The technical field relates to a conductive ink composition and a transparent conductive film made by the conductive ink composition.

### BACKGROUND

It is found that nano-size metal materials present many characteristics that are different from those of the past, what with the research and development of nanotechnology in recent years. The optical, magnetic, thermal, diffusive, and mechanical properties of nano-size metal materials are very different from micro-size metal materials, and nano-size metal materials are potentially applicable in various aspects. Generally, one-dimensional nano-structure materials refer to materials having nano-sizes in a two-dimensional direction, and the length of the materials may not be limited to a nano-size, for example, nanotubes, nano rods, nano fibers, and nano wires.

Transparent conductive films are very important in the display and solar-energy fields. As flat-panel displays are mass produced recently, the supply of indium tin oxide (ITO) materials are almost depleted in fabricating transparent conductive films and manufacturing integrated film transistors. To this end, there are many research institutions seeking viable substitutions. In addition, replacements for ITO material have been successively proposed because of the continuously soaring price of ITO material, the limitations of ITO material in large-size production, and rise and development of the flexible electronic industries. Therefore, the application and development of nano-metal wires in transparent conductive film have become increasingly important. However, the development of transparent conductive films made by nano-metal wires is subject to limitations imposed by the stability of the nano-metal wire ink. In the case of high metal wires solid content, the metal wires having a high aspect ratio are easily agglomerate and precipitate. As the result, the metal wire ink cannot be preserved for a long period of time. Thus, the solid content of metal wires in the ink is usually lowered to a very small amount and a great amount of thickener or binder is added in order to prevent the sedimentation of the nano-metal wires. However, the conductivity of the transparent conductive film made by nano-metal wires do not bear comparison with the transparent conductive film made by ITO due to the small amount of metal wires solid content and additional thickener or binder. Meanwhile, the haze has been raised. In addition, the coating thickness of the nano-metal wire ink has to be increased in order to fabricate a transparent film with high electro-conductivity. However, thickening the nano-metal wire coating does not satisfy the current demand for thinner electronic devices. Therefore, to replace ITO with nano-wire conductive film, the conductivity and optical-property problems should be overcome.

### BRIEF SUMMARY

One embodiment of the disclosure provides a conductive ink composition, including: 100-70 parts by weight of solvent; 0.05-10 parts by weight of nano-metal wires; and 0.01-20 parts by weight of dispersant, wherein the dispersant includes alkyl benzene sulfonate, alkylphenyl sulfonate, alkyl naphthalene sulfonate, sulfate of higher fatty acid ester, sulfonate of higher fatty acid ester, sulfate of higher alcohol ester, sulfonate of higher alcohol ester, or a combination thereof.

One embodiment of the disclosure also provides a transparent conductive film, including: a substrate; and a nano-metal wire layer formed on the substrate, wherein the nano-metal wire layer comprises a plurality of nano metal wires and a dispersant, and wherein the dispersant includes alkyl benzene sulfonate, alkylphenyl sulfonate, alkyl naphthalene sulfonate, sulfate of higher fatty acid ester, sulfonate of higher fatty acid ester, sulfate of higher alcohol ester, sulfonate of higher alcohol ester, or a combination thereof.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGS. 1-2 are cross sectional views showing a structure of transparent conductive film in accordance with the exemplary embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The disclosure utilizes a specific dispersant as an additive in the nanowire-based conductive ink. This can increase the metal wire solid content of the nanowire-based conductive ink and improve the stability of the ink, thereby allowing the nanowire-based conductive ink to have a high metal solid content for standing a long period of time with no agglomeration and precipitation. The nanowire-based conductive ink of the disclosure includes 0.05-10 parts by weight of nano-metal wires, 0.01-20 parts by weight of dispersant and 100-70 parts by weight of solvent. The ratio of components may be adjusted in accordance with the conductivity and coating requirements, for example, 5-8 parts by weight of nano-wires, 10-15 parts by weight of dispersant, and 100-70 parts by weight of solvent. In some embodiments, the nano-metal wire may include copper, gold, nickel, silver, alloys thereof, or a combination thereof. In one embodiment, the aspect ratio of the nano-metal wires may be about 100. In another embodiment, the aspect ratio of the nano-metal wire may be 100-2000.

The dispersant may include alkyl benzene sulfonate, alkylphenyl sulfonate, alkyl naphthalene sulfonate, or a combination thereof. In some embodiments, the dispersant may include dispersants with a carbon number greater than 5, such as sulfate of higher fatty acid ester, sulfonate of higher fatty acid ester, sulfate of higher alcohol ester, sulfonate of higher alcohol ester, or a combination thereof. More specifically, the dispersant may be polystyrene sulfonate, sodium dodecyl sulfate (SDS), sodium dodecylbenzene sulfonate (SDBS), or a combination thereof. In other embodiments, the dispersant may include thiophene-containing dispersants, for example, poly(3,4-ethylenedioxythiophene (PEDOT), mixture of PEDOT and poly(styrenesulfonate) (PSS), or the like.

The solvent may be any suitable polar solvent, including water, alcohols (for example, methanol, ethanol, propanol, butanol, or the like), ketones (for example, acetone, methyl butyl ketone, methyl isobutyl ketone, or the like), or a combination thereof.

The conductive ink may further include 0.05-10 parts by weight of wetting agent. The ratio of wetting agent may be adjusted in accordance with the requirements, for example, 2-5 parts by weight. In some embodiment, the wetting agent may include hydroxypropyl methylcellulose (HPMC) or octyl phenoxy poly ethoxy (for example, Triton X-100).

Compared to conventional conductive inks, with the chosen dispersant of the disclosure, the metal wires solid content may be increased to about 3% and the metal wires with a higher aspect ratio may be used. In addition, the pot of the conductive ink may be increased as well as the stability of the conductive ink under a long period of standing, and also the precipitation of the conductive ink is significantly minimized.

Additionally, the conductive ink may further include 0.05-10 parts by weight of adhesion promoter. The addition of adhesion promote in fabricating conductive films may improve the adhesion of metal wires on the substrate. In some embodiments, the adhesion promoter may include tetramethyloxysilane (TMOS), tetraethoxysilane (TEOS), tetrapropyloxysilane (TPOS), or a combination thereof.

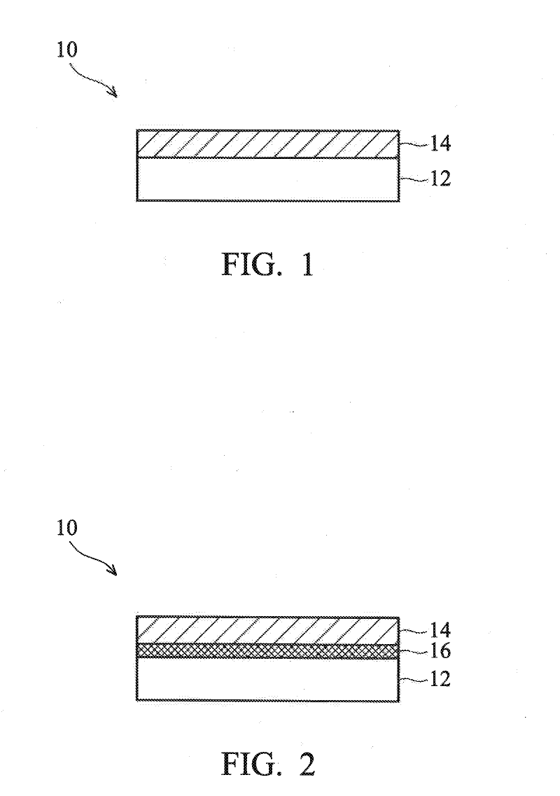

Compared to the transparent conductive films made by conventional conductive inks, the transparent conductive films made by the conductive ink of the disclosure have a higher electro-conductivity and a higher transmittance. Referring to FIG. 1, a cross-sectional view of a transparent conductive film 10 is illustrated in accordance with an exemplary embodiment. As shown in the figure, the transparent conductive film 10 includes a substrate 12. In the embodiments, the substrate 12 may be a rigid substrate or a flexible substrate, for example, glass, plastic, synthetic resin, or the like. In one embodiment, the substrate 12 is a flexible substrate, including polyimide (PI), polycarbonate (PC), polyethylene (PE), polypropylene (PP), polyvinyl alcohol (PVA), polymethylmethacrylate (PMMA), polyethylene terephthalate (PET), polyethylene naphthalate (PEN), parylene, epoxy resin, polyvinyl chloride (PVC), cyclo-olefin polymer (COP), cyclic olefin copolymer (COC), or the like. However, the substrate 12 may also include other flexible materials, for example, organic/inorganic composite substrate, glass, metallic foil sheet, or the like. The thickness of the substrate 12 is about 20-300 μm. In another embodiment, the thickness of the substrate is about 50-200 μm.

The transparent film 10 also includes a nano-metal wire layer 14 formed on the substrate 12. The nano-metal wire layer 14 is formed by applying the above-mentioned nanowire-based conductive ink on the substrate 12. In the embodiments, the application of the nanowire-based conductive ink may include, but not be limited to: spin coating, casting, microgravure coating, gravure coating, blade coating, bar coating, roll coating, wire-bar coating, dip coating, spray coating, screen printing, flexo-printing, offset printing, inkjet printing, or the like. Depending on the conductivity requirements of the transparent conductive film, for example, the coating thickness of the nano-metal wire ink may be 0.5-100 μm. In another embodiment, the coating thickness of the nano-metal wire ink may be 5-30 μm. Next, the substrate 12 with the nano-metal wire ink coated thereon is dried at a temperature of 40-80° C. for 1 minute, preferably 60° C. for 1 minute, and then at 120-160° C. for 10 minutes, preferable 140° C. for 10 minutes.

In addition, referring to FIG. 2, the transparent film may further include a base coating 16 formed between the substrate 12 and the nano-metal wire layer 14. Forming a base coating 16 on the substrate 12 as a base layer before the formation of the nano-metal wire layer 14 may effectively improve the optical and conductive property of the transparent conductive film. In one embodiment, the base coating 16 is an inorganic substance, such as oxide, silicate, hydroxide, carbonate, sulfate, phosphate, sulfide, or a combination thereof. In some embodiments, the base coating 16 is an oxide, for example, silicon oxide (SiOₓ), tin oxide (SnOₓ), titanium oxide (TiOₓ), zinc oxide (ZnOₓ), aluminum oxide (AlOₓ), zirconium oxide (ZrOₓ), indium oxide (InOₓ), antimony oxide (SbOₓ), tungsten oxide (WOₓ), yttrium oxide (YOₓ), magnesium oxide (MgOₓ), cerium oxide (CeOₓ), the above-mentioned oxides containing dopants, or a combination thereof. The base coating 16 may be formed by any suitable coating process, including, but not limited to: spin coating, blade coating, roll coating, wire-bar coating, spray coating or the like. In yet other embodiments, the base coating 16 is a silicate, including smectite clay, vermiculite, halloysite, sericite, saponite, mica, or the like. Depending on the conductivity requirements of the transparent conductive film, for example, the coating thickness of the base coating 16 may be 0.5-100 μm. The formation of the base coating is then completed by drying the substrate 12 with base coating 16 coated thereon at 60-140° C., preferably 120° C.

The advantages of the disclosure are that specific dispersants added into the conductive ink can increase the metal wire solid content of the conductive ink as well as the pot life of the conductive ink. In addition, metal wires with a higher aspect ratio may be used, and also the precipitation of the conductive ink is significantly minimized. Moreover, adding a supplementary adhesion promoter may effectively improve the adhesion of nano-metal wires on the substrate. It is also found that the addition of an adhesion promoter in an appropriate amount does not affect the light transmittance or the conductivity of the transparent conductive film. By using the conductive ink of the disclosure, the obtained transparent conductive films may have a higher conductivity since the metal wires solid content is higher. Furthermore, compared to the conventional methods, there is no binder added in the conductive ink of the disclosure, and hence the transparent conductive film of the disclosure provides a better light transmittance.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout. It should be noted that, although silver is used as the nano-metal wires in the exemplary embodiments, the nano-metal wires are not limited to silver.

### EXAMPLE 1

1.7 g polyvinylpyrrolidone (PVP), 5.63 g tetraethylammonium chloride (TEAC) and 100 ml glycerol were added into a double neck flask and heated to 150° C. Next, 0.578 g AgNO₃ was added into the above solution and the temperature was maintained at 150° C. Forty-five minutes later, the solution was cooled in an ice bath. The solution was added to water and then centrifuged three times. Finally, solid silver wires were preserved statically in water.

A conductive ink was prepared as follow: 2 g silver aqueous dispersion (a solid content of 0.5%), 0.16 g polystyrene sulfonate (PSS), 0.5 g hydroxypropyl methylcellulose (HPMC) solution (a solid content of 2%) as the wetting agent, and 0.1 g n-propyl alcohol (nPA) were mixed uniformly by magnetic stirrer to obtain a nano-silver wire conductive ink. No precipitation was found even after the conductive ink was left standing at room temperature for at least one week.

The transparent conductive film was prepared by using a polyethylene terephthalate (PET) of a thickness of 125 μm as the substrate. The above conductive ink was applied on the substrate by wire-bar coating and then baked at 60° C. for 1 minute, and then at 140° C., for 10 minutes to obtain the transparent conductive film.

### EXAMPLE 2

The steps in Example 1 were repeated except that the dispersant PSS was replaced by 0.15 g sodium dodecyl sulfate (SDS).

### EXAMPLE 3

The steps in Example 1 were repeated except that the dispersant PSS was replaced by 0.15 g sodium dodecylbenzene sulfate (SDBS).

### EXAMPLE 4

The steps in Example 1 were repeated except that the wetting agent HPMC was replaced by 0.2 g Triton X-100.

### EXAMPLE 5

The steps in Example 1 were repeated with SiO₂ liquid dispersion (manufactured by Chang Chun Group, dispersion phase was 2-methyl ethyl ketone (MEK), solid content was 30%, average particle size was 10-20 nm) applied on the substrate prior to the application of nano-silver wire conductive ink to form a base coating. The substrate with base coating was then baked at 100° C. Next, the nano-silver wire conductive ink was applied on the SiO₂ layer and baked at 60° C. for 1 minute, and then at 140° C. for 10 minutes to obtain the transparent conductive film.

### EXAMPLE 6

The steps in Example 1 were repeated with SiO₂ liquid dispersion (manufactured by Chang Chun Group, dispersion phase was 2-methyl ethyl ketone (MEK), solid content was 30%, average particle size was 4-6 nm) applied on the substrate prior to the application of nano-silver wire conductive ink to form a base coating. The substrate with base coating was then baked at 100° C. Next, the nano-silver wire conductive ink was applied on the SiO₂ layer and baked at 60° C. for 1 minute, and then at 140° C. for 10 minutes to obtain the transparent conductive film.

### EXAMPLE 7

The steps in Example 1 were repeated with additional 0.01 g tetraethoxysilane (TEOS) as the adhesion promoter added in the conductive ink.

### COMPARATIVE EXAMPLE 1

The steps in Example 1 were repeated except that the dispersant PSS was replaced by 0.15 g didecyldimethyl ammonium chloride (DDAC).

### COMPARATIVE EXAMPLE 2

The steps in Example 1 were repeated except that the dispersant PSS was replaced by 0.15 g cetylpyridinium chloride (CPC).

### COMPARATIVE EXAMPLE 3

The steps in Example 1 were repeated except that the dispersant PSS was replaced by 0.15 g Dupont FSO 100.

### COMPARATIVE EXAMPLE 4

The steps in Example 1 were repeated except that no dispersant was added.

Characteristic Test for Conductive Inks Formed of Different Dispersants

The conductivities and light transmittances of the transparent conductive film of Examples 1-4 and Comparative Examples 1-4 were measured by utilizing a four-point be and a UV/Visible absorption spectrometer at a wavelength of 550 nm, respectively. The conductive inks were also left standing for one month to record their pot lives, the results are listed in Table 1. It is clear that the nano-silver wire inks of Examples 1-4 have better pot lives (about one week or more) compared to the nano-silver wire inks with additions of commonly used dispersants (Comparative Examples 1-3) or no dispersant (Comparative Example 4) that stratified or precipitated in 1-3 days.

Moreover, referring to Example 1 and Comparative Example 1, the haze of the transparent conductive film made by the dispersant used in Example 1 is only 3.1%, which is lower than the 5% haze of Comparative Example 1 under a same wet film thickness (13.72 μm). In addition, the sheet resistance of the transparent conductive film of Example 1 is lower than that of the transparent conductive film of Comparative Example 3, even better than the non-conductive film of Comparative Examples 1 and 2. In other words, the Examples of the invention have a better conductivity (lower sheet resistance).

TABLE 1

| | Example 1 | | | | Example 2 | | | |
|---|---|---|---|---|---|---|---|---|
| Pot Life | Excellent (more than one week) | | | | Good (about one week) | | | |
| bar coater number | #4 | #6 | #8 | #9 | #5 | #6 | #7 | #8 |
| (wet film thickness, um) | (9.14) | (13.72) | (18.29) | (20.57) | (11.43) | (13.72) | (16.00) | (18.29) |
| transmittance (%) | 90.2 | 89 | 88.1 | 87.6 | 90.1 | 89.5 | 89.1 | 88.8 |
| sheet resistance (Ω/Υ) | 199 | 72 | 36 | 29 | 205 | 102 | 135 | 66 |
| haze (%) | 2.8 | 3.1 | 3.6 | 4 | 3 | 4 | 5.9 | 4.3 |
| | Example 3 | | | | Example 4 | | | |
| Pot Life | Good (about one week) | | | | Excellent (more than one week) | | | |
| bar coater number | #5 | #7 | #8 | #9 | #6 | #7 | #8 | #9 |
| (wet film thickness, um) | (11.43) | (16.00) | (18.29) | (20.57) | (13.72) | (16.00) | (18.29) | (20.57) |
| transmittance (%) | 90 | 89.2 | 88.9 | 88 | 88.1 | 87.5 | 86.5 | 85.5 |
| sheet resistance (Ω/Υ) | 180 | 108 | 69 | 49 | 245 | 160 | 76 | 51 |
| haze (%) | 2.9 | 4.5 | 4.6 | 5.8 | 5.1 | 6.8 | 6.4 | 6.7 |

| | Comparative Example 1 | | | Comparative Example 2 | | | |
|---|---|---|---|---|---|---|---|
| Pot Life | Poor (less than one day) | | | Poor (less than one day) | | | |
| bar coater number | #4 | #5 | #6 | #4 | #5 | #6 | #7 |
| (wet film thickness, um) | (9.14) | (11.43) | (13.72) | (9.14) | (11.43) | (13.72) | (16.00) |
| transmittance (%) | 90.6 | 90 | 88.9 | 90.7 | 90.1 | 89.2 | 88.7 |
| sheet resistance (Ω/Υ) | the resistance could not be measured | | | the resistance could not be measured | | | |
| | due to the poor surface uniformity | | | due to the poor surface uniformity | | | |
| haze (%) | 3.3 | 2.9 | 5 | 2.7 | 2.7 | 4.6 | 5.2 |

| | Comparative Example 3 | | | | Comparative Example 4 | | | |
|---|---|---|---|---|---|---|---|---|
| Pot Life | Fair (about 3 days) | | | | Poor (less than one day) | | | |
| bar coater number | #5 | #6 | #7 | #9 | #4 | #6 | #8 | #9 |
| (wet film thickness, um) | (11.43) | (13.72) | (16.00) | (20.57) | (9.14) | (13.72) | (18.29) | (20.57) |
| transmittance (%) | 90.2 | 89.6 | 89.4 | 88.2 | 90.2 | 89.3 | 88.3 | 87.7 |
| sheet resistance (Ω/Υ) | 344 | 86 | 55 | 32 | 121 | 52 | 26 | 20 |
| haze (%) | 2.5 | 3.5 | 3.9 | 5 | 2.5 | 3.8 | 4.8 | 5.3 |

Characteristic Test for Transparent Conductive Films Having Base Coating

The optical properties and conductivities of the transparent conductive films having base coating (Examples 5 and 6) are listed in Table 2. As shown in Tables 1-2, the sheet resistances of Example 5 and Example 6 (44Ω/γ and 43Ω/δ, respectively) are smaller than that of Example 1, Example 2, Comparative Example 1, and Comparative Example 2 (72Ω/γ, 102Ω/δ, non-measurable, and non-measurable, respectively). In other words, the conductivity and light transmittance f the transparent conductive film may be improved by additionally forming a base coating.

TABLE 2

| | Example 5 | | | | | | Example 6 | | | | | |
|---|---|---|---|---|---|---|---|---|---|---|---|---|
| bar coater number | #3 | #4 | #5 | #6 | #7 | #9 | #3 | #4 | #5 | #6 | #7 | #9 |
| (wet film thickness, um) | (6.86) | (9.14) | (11.43) | (13.72) | (16.00) | (20.57) | (6.86) | (9.14) | (11.43) | (13.72) | (16.00) | (20.57) |
| transmittance (%) | 91.3 | 90.4 | 89.4 | 88 | 86.9 | 84.7 | 91.3 | 90.6 | 90.3 | 88.9 | 87.8 | 85.6 |
| sheet resistance (Ω/Υ) | 233 | 112 | 72 | 44 | 33 | 23 | 220 | 97 | 74 | 43 | 35 | 24 |
| haze (%) | 2.5 | 3 | 3.1 | 3.7 | 4.1 | 4.9 | 1.6 | 1.7 | 2 | 2.6 | 3.4 | 4.1 |

Characteristic Test for Transparent Conductive Films with Additions of Adhesion Promoter

The transparent conductive films of Example 1 and Example 7 were attached with Scotch tape (series 600) for 5 minutes. Next, the tape was torn off in a direction perpendicular to the transparent conductive films and the sheet resistances of the transparent conductive films were measured. The tape was applied and removed several times and the variations of sheet resistance were measured and listed in Table 3. The rate of variations of sheet resistance of the transparent conductive film of Example 7 is lower after repeatedly applying and removing the tape. Table 3 shows the weather resistance of the transparent conductive films of Examples 1 and 7.

It is clearly understood that the addition of adhesion promoter improves the adhesion of nano-wires on the substrate.

TABLE 3

| | Without promoter | | With adhesion promoter | |
|---|---|---|---|---|
| | (Example 1) | | (Example 7) | |
| | sheet | variation | sheet | variation |
| | resistance | of sheet | resistance | of sheet |
| | (Ω/γ) | resistance | (Ω/γ) | resistance |
| Before tape testing | 100 | 0 | 103 | 0 |
| apply and remove tape | 185 | +85% | 131 | +27% |
| once | | | | |
| apply and remove | 227 | +127% | 145 | +41% |
| tape twice | | | | |
| apply and remove tape | 355 | +255% | 178 | +73% |
| three times | | | | |
| apply and remove tape | 496 | +396% | 255 | +148% |
| four times | | | | |

It will be apparent to those skilled in the art that various modifications and variations can be made to the disclosed embodiments. It is intended that the specification and examples be considered as exemplary only, with a true scope of the disclosure being indicated by the following claims and their equivalents

What is claimed is:

1. A conductive ink composition, comprising:
100-70 parts by weight of solvent;
0.05-10 parts by weight of nano-metal wires; and
0.01-20 parts by weight of dispersant, wherein the dispersant comprises alkyl benzene sulfonate, alkylphenyl sulfonate, alkyl naphthalene sulfonate, sulfate of higher fatty acid ester, sulfonate of higher fatty acid ester, sulfate of higher alcohol ester, sulfonate of higher alcohol ester, or a combination thereof.

2. The conductive ink composition of claim 1, wherein the nano-metal wires comprises silver, copper, nickel, gold, or a combination thereof.

3. The conductive ink composition of claim 2, wherein the aspect ratio of the nano-metal wires is 100-2000.

4. The conductive ink composition of claim 1, wherein the dispersant comprises sodium dodecyl sulfate, sodium dodecylbenzene sulfonate, poly(styrene sulfonate), or a combination thereof.

5. The conductive ink composition of claim 1, wherein the dispersant is a thiophene-containing dispersant, comprising poly(3,4-ethylenedioxythiophene), or a mixture of poly(3,4-ethylenedioxythiophene) and poly(styrenesulfonate).

6. The conductive ink composition of claim 1, wherein the solvent comprises water, alcohol, ketone, or a combination thereof.

7. The conductive ink composition of claim 1, further comprising 0.05-10 parts by weight of wetting agent.

8. The conductive ink composition of claim 7, wherein the wetting agent comprises hydroxypropyl methylcellulose or octyl phenoxy poly ethoxy.

9. The conductive ink composition of claim 1, further comprising 0.05-10 parts by weight of adhesion promoter.

10. The conductive ink composition of claim 9, wherein the adhesion promoter comprises tetramethyloxysilane, tetraethoxysilane, tetrapropyloxysilane, or a combination thereof.

11. A transparent conductive film, comprising:
a substrate; and
a nano-metal wire layer formed on the substrate, wherein the nano-metal wire layer comprises a plurality of nano-metal wires and a dispersant, and wherein the dispersant comprises alkyl benzene sulfonate, alkylphenyl sulfonate, alkyl naphthalene sulfonate, sulfate of higher fatty acid ester, sulfonate of higher fatty acid ester, sulfate of higher alcohol ester, sulfonate of higher alcohol ester, or a combination thereof.

12. The transparent conductive film of claim 11, wherein the nano-metal wires comprises silver, copper, nickel, gold, or a combination thereof.

13. The transparent conductive film of claim 12, wherein the aspect ratio of the nano-metal wires is 100-2000.

14. The transparent conductive film of claim 11, wherein, the dispersant comprises sodium dodecyl sulfate, sodium dodecylbenzene sulfonate, poly(styrenesulfonate), or a combination thereof.

15. The transparent conductive film of claim 11, wherein the dispersant is a thiophene-containing dispersant, comprising poly(3,4-ethylenedioxythiophene), or a mixture of poly(3,4-ethylenedioxythiophene) and poly(styrenesulfonate).

16. The transparent conductive film of claim 11, wherein the nano-metal wire layer further comprising a wetting agent, the wetting agent comprises hydroxypropyl methylcellulose or octyl phenoxy poly ethoxy.

17. The transparent conductive film of claim 11, wherein the nano-metal wire layer further comprising an adhesion promoter, wherein the adhesion promoter comprises tetramethyloxysilane, tetraethoxysilane, tetrapropyloxysilane, or a combination thereof.

18. The transparent conductive film of claim 11, further comprising a base coating formed between the substrate and the nano-metal wire layer.

19. The transparent conductive film of claim 18, wherein the base coating comprises oxide, silicate, hydroxide, carbonate, sulfate, phosphate, sulfide, or a combination thereof.

20. The transparent conductive film of claim 18, wherein the base coating is an oxide, comprising silicon oxide (SiOₓ), tin oxide (SnOₓ), titanium oxide (TiOₓ), zinc oxide (ZnOₓ), aluminum oxide (AlOₓ), zirconium oxide (ZrOₓ), indium oxide (InOₓ), antimony oxide (SbOₓ), tungsten oxide (WOₓ), yttrium oxide (YOₓ), magnesium oxide (MgOₓ), cerium oxide (CeOₓ), the above-mentioned oxides containing dopants, or a combination thereof.

21. The transparent conductive film of claim 18, wherein the base coating is a silicate, comprising smectite clay, vermiculite, halloysite, sericite, saponite, or mica.
